(19) United States
(12) Patent Application Publication
(10) Pub. No.: US 2025/0071801 A1
(43) Pub. Date: Feb. 27, 2025

(54) SYSTEMS AND METHODS FOR OPTIMAL DEEP LEARNING SIGNAL CLASSIFICATION WITH WAVELET COMPRESSIVE SENSING

(71) Applicant: Eagle Technology, LLC, Melbourne, FL (US)

(72) Inventors: Mark D. Rahmes, Melbourne, FL (US); Mike Garrett, Melbourne, FL (US); John Penuel, Indian Harbour Beach, FL (US); David B. Chester, Palm Bay, FL (US); Chad Chung Lau, Melbourne, FL (US)

(21) Appl. No.: 18/940,999

(22) Filed: Nov. 8, 2024

Related U.S. Application Data
(63) Continuation-in-part of application No. 18/462,760, filed on Sep. 7, 2023.
Application No. 18/462,760 is a continuation of application No. 17/200,257, filed on Mar. 12, 2021, now Pat. No. 11,792,839.

(51) Int. Cl. H04W 72/563; G06N 5/04; G06N 20/00

(52) U.S. Cl. CPC H04W 72/563; G06N 5/042; G06N 20/00

(57) ABSTRACT

Systems and methods for operating a quantum processor. The methods comprise: training one or more quantum neural networks using modulation class data to make decisions as to a modulation classification for a signal based on one or more feature inputs for the signal; obtaining, by the quantum processor, principle components of real and imaginary components of a signal received by a communication device; and performing first quantum neural network operations by the quantum processor using the principle components as inputs to the trained one or more quantum neural networks to generate a plurality of scores, wherein each said score represents a likelihood that the received signal was modulated using a given modulation type of a plurality of different modulation types.

### CROSS-REFERENCE TO RELATED APPLICATIONS

The present application is a Continuation-in-Part Application of and claims the benefit of U.S. Non-Provisional patent application Ser. No. 18/462,760, which was filed on Sep. 7, 2023 and is a continuation application that claims priority to and the benefit of U.S. Non-Provisional patent application Ser. No. 17/200,257 which was filed on Mar. 12, 2021. The content of these Non-Provisional Patent Applications is incorporated herein by reference in its entirety.

### STATEMENT OF THE TECHNICAL FIELD

The present disclosure relates generally to communication systems. More particularly, the present disclosure relates to implementing systems and methods for controlling communications based on machine learned information.

### DESCRIPTION OF THE RELATED ART

Wireless communication systems exist today, and are used in various applications. Some of these wireless communication systems comprise cognitive radios. A cognitive radio is a radio that is configured to dynamically use wireless channels to avoid user interference and congestion. During operations, the cognitive radio detects which of the wireless channels is (are) available, and then configures its parameters to facilitate use of the available communication channel(s).

### SUMMARY

The present disclosure concerns implementing systems and methods for operating a quantum processor. The methods comprise: training one or more quantum neural networks using modulation class data to make decisions as to a modulation classification for a signal based on one or more feature inputs for the signal; obtaining, by the quantum processor, principle components of real and imaginary components of a signal received by a communication device; and performing first quantum neural network operations by the quantum processor using the principle components as inputs to the trained one or more quantum neural networks to generate a plurality of scores, each said score representing a likelihood that the received signal was modulated using a given modulation type of a plurality of different modulation types

The present disclosure also concerns a quantum circuit, comprising: one or more quantum neural networks trained using modulation class data to make decisions as to a modulation classification for a signal based on one or more feature inputs for the signal; and a quantum processor. The quantum processor is configured to: obtain principle components of real and imaginary components of a signal; and perform first quantum neural network operations using the principle components as inputs to the one or more quantum neural networks to generate a plurality of scores. Each score represents a likelihood that the signal was modulated using a given modulation type of a plurality of different modulation types.

The present disclosure further concerns a communication device comprising: a wireless communications circuit configured to receive a signal; and a quantum circuit. The quantum circuit comprises: one or more quantum neural networks trained using modulation class data to make decisions as to a modulation classification for the signal based on one or more feature inputs for the signal; and a quantum processor. The quantum processor is configured to: obtain principle components of real and imaginary components of the signal; and perform first quantum neural network operations using the principle components as inputs to the one or more quantum neural networks to generate a plurality of scores. Each score represents a likelihood that the signal was modulated using a given modulation type of a plurality of different modulation types.

### BRIEF DESCRIPTION OF THE DRAWINGS

The present solution will be described with reference to the following drawing figures, in which like numerals represent like items throughout the figures.

FIG. 1 provides an illustration of an illustrative signal classification system.

FIG. 2 provides an illustration of an illustrative system configured to perform signal recognition and classification in accordance with the present solution.

FIG. 3 provides a flow diagram of an illustrative method for operating the system of FIG. 1.

FIG. 4 provides a block diagram of an illustrative communication device.

FIG. 5 provides a table showing illustrative machine learn related information.

FIG. 6 provides a block diagram of an illustrative cognitive sensor.

FIG. 7 provides graphs that are useful for understanding operations of the cognitive sensor shown in FIG. 6.

FIGS. 8-10 provide illustrations of illustrative machine learning algorithm architectures.

FIG. 11 provides a table that is useful for understanding game theory.

FIG. 12 provides a graph that is useful for understanding game theory.

FIG. 13 provides a flow diagram of an illustrative method for determining an availability of channel(s) in a wireless spectrum.

FIG. 14 provides an illustration of another illustrative signal classification system implementing quantum neural network(s) and quantum subset summing approximation.

FIG. 15 provides an illustration that is useful for understanding quantum neural network model training.

FIG. 16 provides illustrations of quantum circuit classifiers.

FIG. 17 provides an illustration that is useful for understanding quantum subset summing approximation.

FIG. 18 provides an illustration of an illustrative quantum comparator circuit.

FIGS. 19 and 20 each provide an illustration of an illustrative quantum adder circuit.

FIGS. 21A-21B (collectively referred to as “FIG. 21”) provides a flow diagram of an illustrative method for operating a quantum processor.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Signal recognition and classification has been accomplished using feature-based, expert-system-driven (i.e., non-machine-learning) techniques. The feature-based, expert-system-driven techniques are relatively computationally slow and costly to implement. The present solution provides an alternative solution for signal recognition and classification that overcomes the drawbacks of conventional feature-based, expert-system-driven solutions.

The present solution employs a machine-learning based approach which provides a faster, less-expensive path to adding new signals to a list of recognized signals, offers better recognition performance at lower Signal-to-Noise Ratios (SNRs), and recognizes signals and sources thereof faster and with an improved accuracy as compared to that of the conventional feature-based, expert-system-driven solutions. In some scenarios, the machine-learning based approach uses expert systems and/or deep learning to facilitate signal recognition and classification. The deep learning can be implemented by one or more neural networks (e.g., Residual Neural Network(s) (ResNet(s)), Convolutional Neural Network(s) (CNN(s)), and/or quantum neural network(s)). The individual neural networks may be comprised of numerous stacked layers of various modalities to provide a plurality of layers of convolution. The neural networks are trained to automatically recognize and determine modulation types of received wireless communication signals from digitally sampled and processed data. This training can be achieved, for example, using a dataset that includes information for signals having SNRs from −20 dB to +30 dB and being modulated in accordance with a plurality of analog and/or digital modulation schemes (e.g., phase shift keying, and/or amplitude shift keying).

The machine-learning based approach of the present solution can be implemented to provide a cognitive, automated system to optimize signal classification analyses by modulation choices from data with various SNRs (e.g., SNRs from −20 dB to +30 dB). Subsystems can include, but are not limited to, a tuner, a digitizer, a classifier, and/or an optimizer. Fast recognition and labeling of Radio Frequency (RF) signals in the vicinity is a needed function for Signal Intelligence (SIGINT) devices, spectrum interference monitoring, dynamic spectrum access, and/or mesh networking.

Artificial intelligence (AI) algorithms and/or game theoretic analysis may be used to help solve the problem of signal classification through supervised classification. The game theory analysis provides a flexible framework to model strategies for improved decision-making optimization. Classification strategies may be based on different supervised gradient descent learning algorithms and/or different neural network structures. Individual trainable networks are the potential decisions of a one-sided, single-player game vs. nature, and the action is to choose the goodness-of-fit weighting of the composite network for optimal decision making. A novel, game-theoretic perspective has been derived for solving the problem of supervised classification that takes the best signal modulation prediction derived from supervised classification models. In this one-player game, the system determines the modulation type by choosing the best network model from a plurality of network models at a given time. Within this formulation, a reward matrix (weighted or non-weighted) is used for consistent classification factors that results in higher accuracy and precision compared to using individual machine learning models alone.

The reward matrix comprises an M×C matrix, where M is the number of machine learned models and C is the number of modulation classes. The reward matrix uses goodness-of-fit-predicted class scores or responses in the form of a matrix based on the number of signals and modulation classes. These goodness-of-fit-predicted class scores are used in a linear program to optimally choose which machine learned model to use per signal. For example, a machine learned model can be selected in accordance with the following mathematical equation:

$$maximize f ( x ) subject to$$

$$Ax \leq b$$

$$x \geq 0$$

where x represents a decision variable, A represents coefficients in a reward matrix, b represents coefficients which satisfy constraints, and f represents a linear objective function of constants.

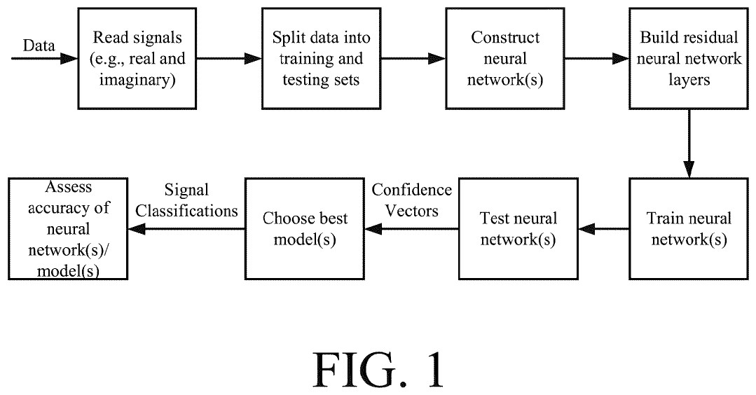

FIG. 1 presents an overview of the signal classification system. The signal classification system is generally configured to generate machine learned models including sets of signal features/characteristics that can be used to recognize and classify signals and/or sources of signals. These sets of signal features/characteristics are then stored in a datastore(s) and/or used by communication devices (e.g., cognitive radios) to determine, for example, whether wireless channels are available or unavailable.

The communication devices can include, but are not limited to, cognitive radios configured to recognize and classify radio signals by modulation type at various Signal-to-Noise Ratios (SNRs). Each of the cognitive devices comprises a cognitive sensor employing machine learning algorithms. In some scenarios, the machine learned algorithms include neural networks which are trained and tested using an extensive representative dataset consisting of 24 or more digital and analog modulations. The neural networks learn from the time domain amplitude and phase information of the modulation schemes present in the training dataset. The machine learning algorithms facilitate making preliminary estimations of modulation types and/or signal sources based on machine learned signal feature/characteristic sets. Linear programming optimization may be used to determine the best modulation classification based on prediction scores output from one or more machine learning algorithms.

A communication device can significantly reduce the potentially massive memory storage requirements needed for training data by using compressive sensing techniques, such as but not limited to the Discrete Wavelet Transform (DWT). Data compression techniques such as the DWT transform signals into sparse coefficient sets, and many of the coefficients may be discarded without negatively affecting performance of the communication device. Through this discarding of coefficients, the storage requirements become significantly less than what would have been required for the original signal data.

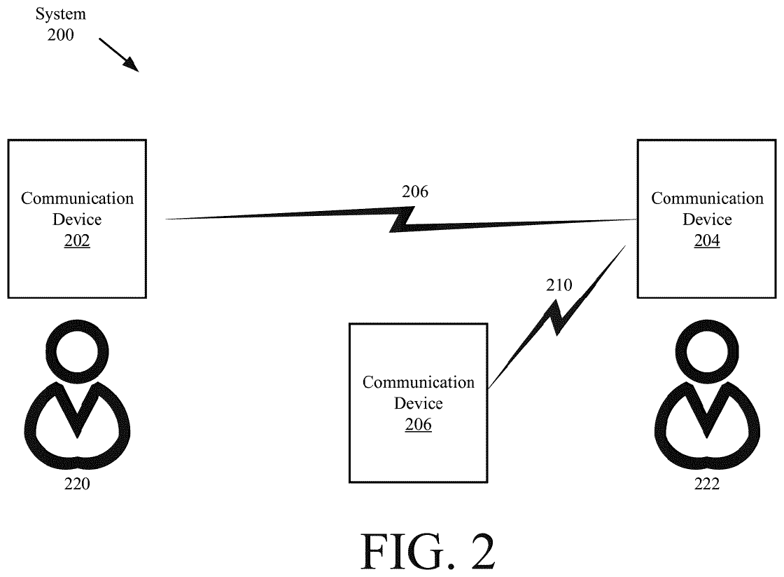

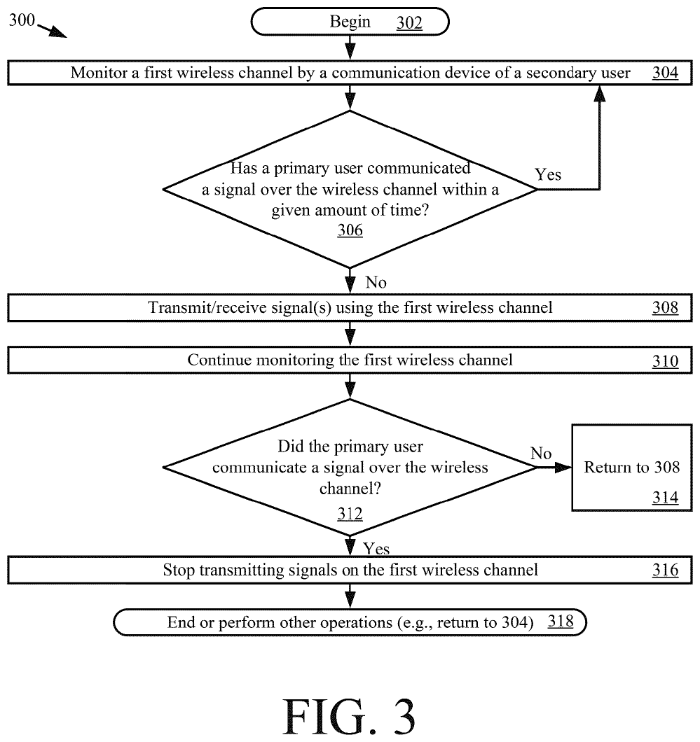

Referring now to FIG. 2, there is provided an illustration of an illustrative communications system 200. Communications system 200 is generally configured to allow communications amongst communication devices 202, 204, 208 over wireless channels 206, 210 in a waveform spectrum. The communication devices can include, but are not limited to, cognitive radios. Each cognitive radio is configured to dynamically share the wireless channels 206, 210 to avoid user interference and congestion. The manner in which the communication devices perform dynamic spectrum sharing and/or dynamically transition between wireless channels will be described below in relation to FIG. 3.

A user 220 of communication device 202 is a primary user of wireless channel 206. As such, the user 220 has first rights to communicate information over wireless channel 206 via communication device 202 a given amount of time (e.g., X microseconds, where X is an integer). User 220 licensed use of the wireless channel 206 to another user 222. User 222 constitutes a secondary user. Accordingly, user 222 is able to use the wireless channel 206 to communicate information to/from communication device 204 during the time in which the wireless channel is not being used by the primary user 220 for wireless communications. Detection of the primary user by the secondary user is critical to the cognitive radio environment. The present solution provides a novel solution for making such detections by secondary users in a shorter amount of time as compared to conventional solutions. The novel solution will become evident as the discussion progresses.

During operations, the communication device 204 monitors communications on wireless channel 206 to sense spectrum availability, i.e., determine an availability of the wireless channel. The wireless channel 206 is available when the primary user 220 is not and has not transmitted a signal thereover for a given amount of time. The wireless channel 206 is unavailable when the primary user 220 is transmitting a signal thereover or has transmitted a signal thereover within a given amount of time. When a determination is made that the wireless channel 206 is unavailable, the communication device 204 performs operations to transition to another wireless channel 210. This channel transition may be achieved by changing an operational mode of the communication device 204 and/or by changing channel parameter(s) of the communication device 204. The communication device 204 may transition back to wireless channel 206 when a determination is made that the primary user 220 is no longer using the same for communications.

Referring now to FIG. 3, there is provided a flow diagram of an illustrative method 300 for operating a system (e.g., system 200 of FIG. 2). Method 300 begins with 302 and continues with 304 where a communication device (e.g., communication device 202 of FIG. 2) of a secondary user (e.g., user 222 of FIG. 2) monitors at least one first wireless channel (e.g., wireless channel 206 of FIG. 2) for availability. This monitoring involves: receiving signals communicated over the first wireless channel(s); and processing the signals to determine whether a primary user (e.g., user 220 of FIG. 2) is using the first wireless channel(s) for communications. If so [306: YES], then the wireless channel(s) is (are) considered unavailable. Accordingly, the communication device continues monitoring the first wireless channel(s). If not [306: NO], then the wireless channel(s) is (are) considered available. As such, the communication device may use the first wireless channel(s) for communicating signals as shown by 308.

As shown by 310, the communication device continues to monitor the first wireless channel(s). The communication device continues to use the wireless channel(s) for a given period of time or until the primary user once again starts using the same for communications, as shown by 312-314. When the communication device detects that the primary user is once again using the wireless channel(s) [312: YES], then the communication device stops transmitting signals on the first wireless channel(s) as shown by 316. Subsequently, 318 is performed where method 300 ends or other operations are performed (e.g., return to 304).

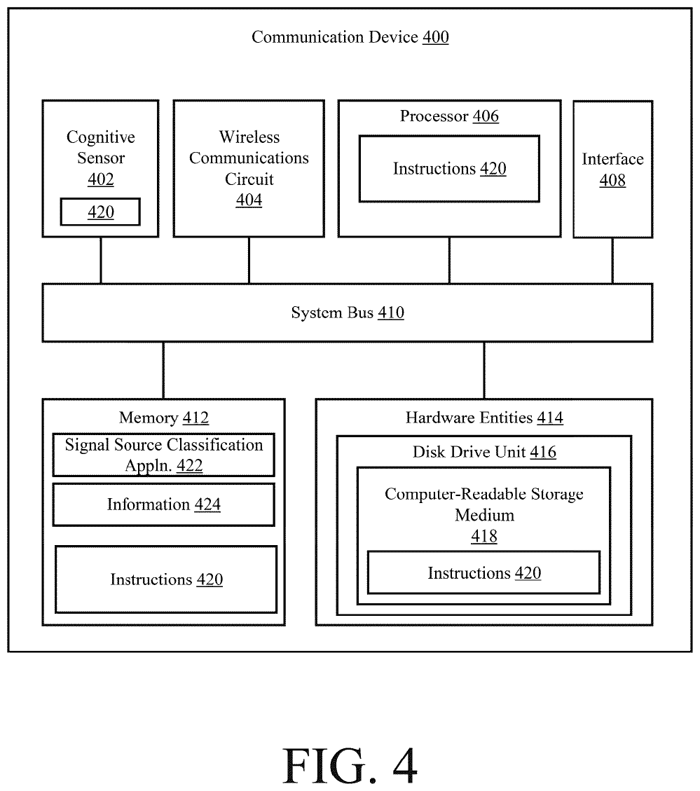

A detailed block diagram of an illustrative architecture for a communication device is provided in FIG. 4. The communication devices 202, 204 and/or 206 of FIG. 2 may be the same as or substantially similar to communication device 400 of FIG. 4. As such, the discussion of communication device 400 is sufficient for understanding communication devices 202, 204, 206 of FIG. 2.

Communication device 400 implements a machine learning algorithm to facilitate determinations as to an available/unavailable state of wireless channel(s) (e.g., wireless channel 206 of FIG. 2). The communication device 400 dynamically transitions communication operations between wireless channels based on the determined available/unavailable state(s) thereof. In this regard, the communication device 400 includes a plurality of components shown in FIG. 4. The communication device 400 may include more or less components than those shown in FIG. 4. However, the components shown are sufficient to disclose an illustrative solution implementing the present solution. The hardware architecture of FIG. 4 represents one implementation of a representative communication device configured to enable dynamic use of wireless channels to avoid user interference and congestion. As such, the communication device 400 of FIG. 4 implements at least a portion of the method(s) described herein.

The communication device 400 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 4, the communication device 400 comprises a cognitive sensor 402, a wireless communications circuit 404, a processor 406, an interface 408, a system bus 410, a memory 412 connected to and accessible by other portions of communication device 400 through system bus 410, and hardware entities 414 connected to system bus 410. The interface 408 provides a means for electrically connecting the communication device 400 to other external circuits (e.g., a charging dock or device).

The cognitive sensor 402 is generally configured to determine a source of a signal transmitted over a wireless channel. This determination is made via a signal source classification application 422 using information 424. Information 424 comprises outputs generated by one or more machine learning algorithms. The machine learning algorithm(s) can employ supervised machine learning. Supervised machine learning algorithms are well known in the art. In some scenarios, the machine learning algorithm(s) include(s), but is (are) not limited to, a deep learning algorithm (e.g., a Residual neural network (ResNet), a Convolutional Neural Network (CNN), and/or a Recurrent Neural Network (RNN) (e.g., a Long Short-Term Memory (LSTM) neural network)). The machine learning process implemented by the present solution can be built using Commercial-Off-The-Shelf (COTS) tools and/or a commercially available Field Programmable Gate Array (FPGA) (e.g., Xilinx Vertex 7 FPGA).

Each machine learning algorithm is provided one or more feature inputs for a received signal, and makes a decision as to a modulation classification for the received signal. In some scenarios, the machine learning algorithms include neural networks that produce outputs hᵢ in accordance with the following mathematical equations.

$${h}_{i} = L ( {w}_{i} ( {x}_{i} ) ) \qquad ( 1 )$$

$${h}_{i} = L ( {w}_{1} ( {x}_{1} ) + {w}_{2} ( {x}_{2} ) + … + {w}_{i} ( {x}_{i} ) ) \qquad ( 2 )$$

where L ( ) represents a likelihood ratio function, w₁, w₁, . . . , wᵢ each represent a weight, and x₁, x₁, . . . , xᵢ represent signal features and/or the raw data. The signal features can include, but are not limited to, a center frequency, a change in frequency over time, a phase, a change in phase over time, amplitude, an average amplitude over time, a data rate, and a wavelength. The output hᵢ includes a set of confidence scores. Each confidence score indicates a likelihood that a signal was modulated using a respective type of modulation. The set of confidence scores are stored in any format selected in accordance with a given application.

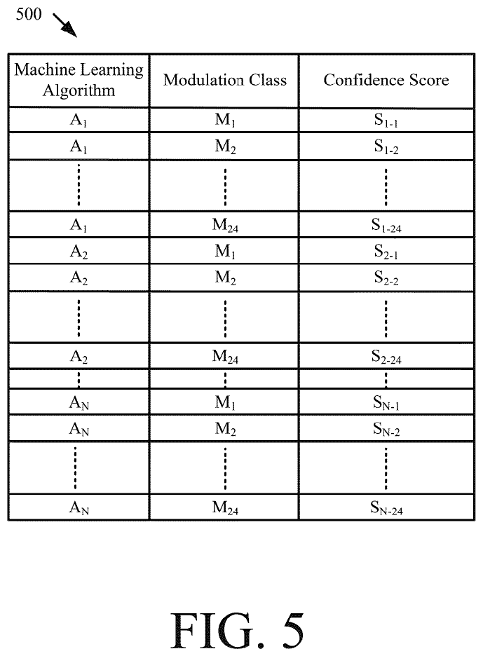

For example, as shown in table 500 of FIG. 5, the 24 confidence scores (e.g., S₁₋₁, S₁₋₂, . . . , S₁₋₂₄, S₂₋₁, S₂₋₂, . . . , S₂₋₂₄, . . . , S_{N-1}, S_{N-2}, . . . , S_{N-24}) are stored in a table format so as to be associated with identifiers for machine learning algorithms (e.g., A1 identifying a first neural network, A2 identifying a second neural network, . . . , A1 identifying an N^{th} neural network) and identifiers for modulation classes (e.g., M₁ identifying a first modulation class, M₂ identifying a second modulation class, . . . , M₂₄ identifying a twenty-fourth modulation class). The modulation classes can include, but are not limited to, On-Off Keying (OOF), 4 Amplitude Shift Keying (ASK), Binary Phase Shift Keying (BPSK), Quadrature Phase Shift Keying (QPSK), 8 Phase Shift Keying (PSK), 16 Quadrature Amplitude Modulation (QAM), OQPSK, 16PSK, 32PSK, 16 Amplitude and Phase Shift Keying (APSK), 32APSK, 64APSK, 128APSK, 16QAM, 32QAM, 64QAM, 128QAM, 256QAM, Amplitude Modulation-Single Sideband-With Carrier (AM-SSB-WC), Amplitude Modulation-Single Sideband-Suppressed Carrier (AM-SSB-SC), Amplitude Modulation-Double Sideband-With Carrier (AM-DSB-WC), Amplitude Modulation-Double Sideband-Suppressed Carrier (AM-DSB-SC), Frequency Modulation (FM), and/or Gaussian Minimum Shift Keying (GMSK). Each confidence score can include, but is not limited to, a likelihood score and/or a goodness-of-fit-predicted score. The goodness-of-fit-predicted score may be calculated based on the number of signals (e.g., 2.5 million) and the number of modulation classes (e.g., 24). The goodness-of-fit-predicted score describes how well the machine learning algorithm and modulation class fit a set of signal observations. A measure of goodness-of-fit summarizes the discrepancy between observed values and the values expected under the machine learning algorithm in question. The goodness-of-fit-predicted score can be determined, for example, using a chi-squared distribution algorithm and/or a likelihood ratio algorithm. The present solution is not limited to the particulars of this example.

The cognitive sensor 402 then performs operations to either (i) select the modulation class associated with the highest confidence score or (ii) select one of the modulation classes for the signal based on results of an optimization algorithm. The optimization algorithm can include, but is not limited to, a game theory based optimization algorithm. The game theory based optimization algorithm will be discussed in detail below.

Once the modulation class has been decided for the received signal, the cognitive sensor 402 then makes a decision as to whether the source of the signal was a primary user of the wireless spectrum. This decision is made based on the modulation class, a bit rate and/or a center frequency of the signal. For example, a decision is made that the primary user is the source of a signal when the signal comprises a 10 MHZ-wide BPSK signal with a center frequency of 2.4 GHz. The present solution is not limited in this regard.

At least some of the hardware entities 414 perform actions involving access to and use of memory 412, which can be a Random Access Memory (RAM), and/or a disk driver. Hardware entities 414 can include a disk drive unit 416 comprising a computer-readable storage medium 418 on which is stored one or more sets of instructions 420 (e.g., software code) configured to implement one or more of the methodologies, procedures, or functions described herein. The instructions 420 can also reside, completely or at least partially, within the memory 412, with the cognitive sensor 420, and/or within the processor 406 during execution thereof by the communication device 400. The memory 412, cognitive sensor 420 and/or the processor 406 also can constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 420 for execution by the processor 406 and that cause the processor 406 to perform any one or more of the methodologies of the present disclosure.

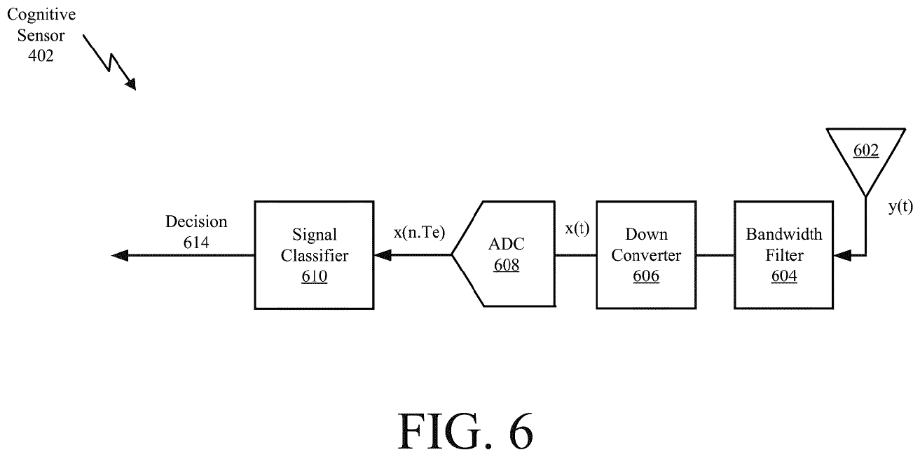

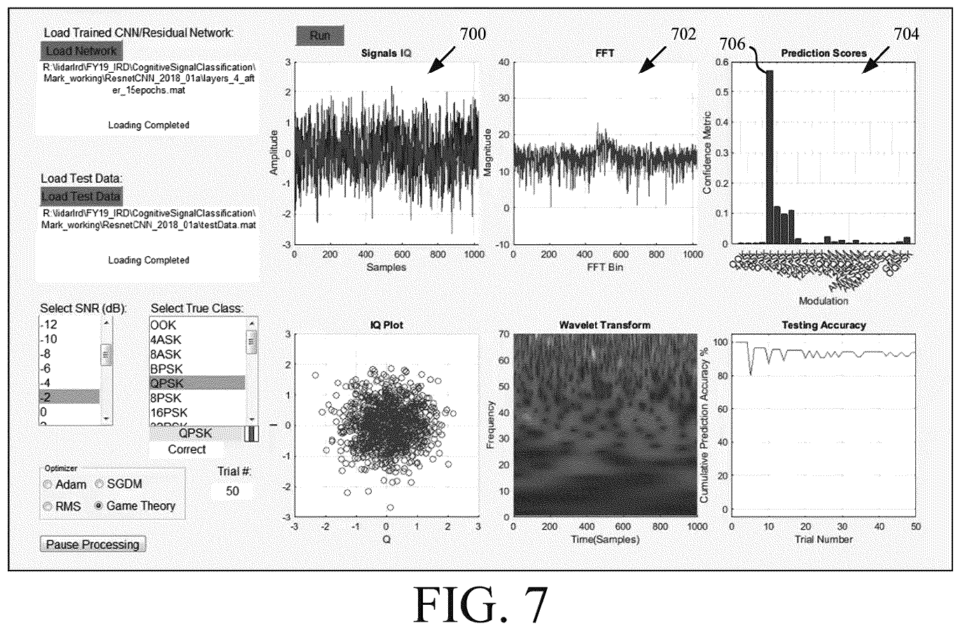

Referring now to FIG. 6, there is provided a more detailed diagram of the cognitive sensor 402. As shown in FIG. 6, cognitive sensor 402 is comprised of an antenna 602, a bandwidth filter 604, a down converter 606, an Analog-to-Digital Converter (ADC) 608, a machine learning algorithm selector 610, and a signal classifier 612. Antenna 602 is configured to receive a radio signal y(t) transmitted from communication devices (e.g., communication device 202, 204 and/or 206 of FIG. 1). An illustrative radio signal 700 is shown in FIG. 7. The received radio signal y(t) is filtered on a bandwidth BL by bandwidth filter 604, and then down converted by down converter 606. The down converted signal x(t) is passed to the input of the ADC 608. ADC 608 is configured to convert analog voltage values to digital values, and communicate the digital values x(n) to the signal classifier 610.

The signal classifier 612 uses one or more machine learning algorithms to (i) detect the radio signal y(t) in the presence of noise and (ii) make a decision 614 as to the modulation classification that should be assigned thereto. For example, as shown in FIG. 7, a trained CNN/neural network is provided a Fast Fourier Transform input signal 702, processes the input signal, and outputs prediction scores 704 for a plurality of modulation classes. The signal is assigned a QPSK modulation class since it is associated with the highest predictions score 706. The present solution is not limited to the particulars of this example. In other scenarios, one of the multiple specific learning algorithms used to train the neural network may be selected, or the ensemble of all of the techniques may be combined in an optimal way. The learning algorithms can include, but are not limited to, Adam, Stochastic Gradient Decent Method, and/or RMSprop; if all techniques available are employed, the outputs from the ensemble of networks trained by multiple techniques may be combined optimally by game theoretic techniques. It should be noted that the modulation class that is selected in accordance with the optimization algorithm may or may not be associated with the highest prediction/likelihood score.

Once the modulation classification has been decided for the signal, the signal classifier 612 performs further operations to determine whether the primary user is the source of the signal. These operations can involve: obtaining the modulation class assigned to the signal; obtaining a bit rate and center frequency for the radio signal; and comparing the modulation class, bit rate and center frequency to pre-stored source information to determine if a match exists therebetween by a certain amount (e.g., the bit rates match by at least 70% and/or the center frequencies match by at least 50%). If a match exists, then the signal classifier 612 decides that the primary user is the source of the radio signal and is using the band BL. Otherwise, the signal classifier 612 decides that someone other than the primary user is the source of the radio signal and trying to encroach on the band BL. If the radio signal y(t) is detected and the primary user is using the band BL, then a decision is made that the band BL is unavailable. Otherwise, a decision is made that the band BL is available.

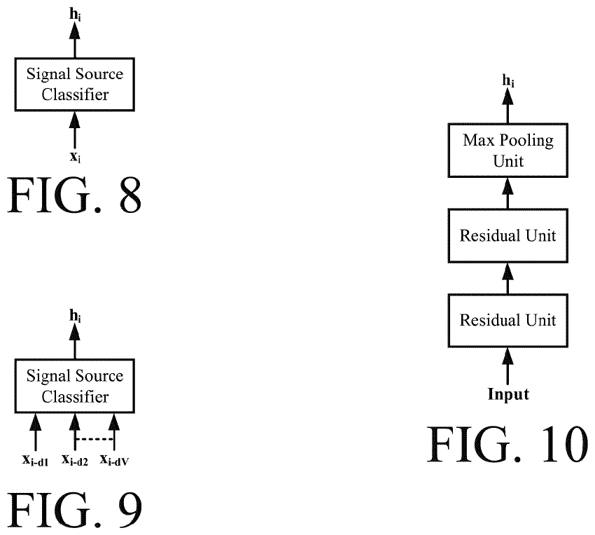

An illustrative architecture for a neural network implementing the present solution is provided in FIG. 8. As shown in FIG. 8, the neural network comprises a signal source classifier that performs one or more machine learning algorithms. Each machine learning algorithm uses an input xᵢ and generates an output hᵢ. The input xᵢ may be provided in a time domain (e.g., defines a waveform shape), a frequency domain, a phase domain and/or an amplitude domain. The output hᵢ comprises a set of prediction/likelihood scores determined for a plurality of modulation classes. In some scenarios, the output hᵢ is determined in accordance with the above provided mathematical equation (1) or (2).

Another illustrative architecture for a neural network implementing the present solution is provided in FIG. 9. As shown in FIG. 9, the neural network comprises a signal source classifier that performs one or more machine learning algorithms. The signal source classifier receives a plurality of inputs x_{i-d1}, x_{i-d2}, . . . , x_{i-dV} and generates an output hᵢ. The inputs may be provided in different domains. For example, input x_{i-d1} is provided in a frequency domain (e.g., defining a change in frequency over time). Input x_{i-d2} is provided in a phase domain (e.g., defining a change in phase over time), while input x_{i-dV} is provided in an amplitude domain (e.g., defining an average amplitude over time) or other domain (e.g., a time domain). The inputs x_{i-d2}, . . . , x_{i-dV} can be derived using various algorithms that include, but are not limited to, a Fourier transform algorithm, a power spectral density algorithm, a wavelet transform algorithm, and/or a spectrogram algorithm. Each machine learning algorithm uses a combination of the inputs to determine a set of prediction/likelihood scores. The inputs x_{i-d1}, x_{i-d2}, . . . , x_{i-dV} may be weighted differently by the machine learning algorithms. The weights can be pre-defined, or dynamically determined based on characteristic(s) of the received waveform. The prediction/likelihood scores are then analyzed to determine a modulation class to be assigned to the radio signal. For example, the modulation class is assigned to the radio signal which is associated with the highest prediction/likelihood score or which is associated with a prediction/likelihood score selected in accordance with an optimization algorithm (e.g., a game theory algorithm).

The present solution is not limited to the neural network architectures shown in FIG. 8-9. For example, the neural network can include a plurality of residual units that perform the machine learning algorithm in a sequential manner as shown in FIG. 10.

As noted above, the modulation class may be selected based on results of a game theory analysis of the machine learned models. The following discussion explains an illustrative game theory optimization algorithm.

Typical optimization of a reward matrix in a one-sided, “game against nature” with a goal of determining the highest minimum gain is performed using linear programming techniques. In most cases, an optimal result is obtained, but occasionally one or more constraints eliminate possible feasible solutions. In this case, a more brute-force subset summing approach can be used. Subset summing computes the optimal solution by determining the highest gain decision after iteratively considering all subsets of the possible decision alternatives.

A game theory analysis can be understood by considering an exemplary tactical game. Values for the tactical game are presented in the following TABLE 1, which is described in a document entitled “Updating Optimal Decisions Using Game Theory and Exploring Risk Behavior Through Response Surface Methodology” written by J. D. Jordan. The unitless values range from −5 to 5, which indicate the reward received performing a given action for a particular scenario. The actions for the player correlate in the rows in TABLE 1, while the potential scenarios correlate to the columns in TABLE 1. For example, the action of firing a mortar at an enemy truck yields a positive reward of 4, but firing a mortar on a civilian truck yields a negative reward of −4, i.e., a loss. The solution can be calculated from a linear program, with the results indicating that the best choice for the play is to advance rather than fire mortar or do nothing. In examples with very large reward matrices, the enhancement technique of subset summing may also be applied. Since there are four scenarios in this example (enemy truck, civilian truck, enemy tank, or friendly tank), there are 2⁴=16 subsets of the four scenarios. One of these subsets considers none of the scenarios, which is impractical. So in practice, there are always 2^{P}−1 subsets, where P is the number of columns (available scenarios) in a reward matrix. TABLE 1 is reproduced from the following document: Jordan, J. D. (2007). Updating Optimal Decisions Using Game Theory and Exploring Risk Behavior Through Response Surface Methodology.

TABLE 1

| | Enemy | Civilian | Enemy | Friendly |
|---|---|---|---|---|
| | Truck | Truck | Tank | Tank |
| Fire Mortar | 4 | −4 | 5 | −5 |
| Advance | 1 | 4 | 0 | 4 |
| Do Nothing | −1 | 1 | −2 | 1 |

The goal of linear programming is to maximize a function over a set constrained by linear inequalities and the following mathematical equations (3)-(9).

$$max z = v + 0 {w}_{1} + 0 {w}_{2} + 0 {w}_{3} \qquad ( 3 )$$

$$s . t . v \leq 4 {w}_{1} + 1 {w}_{2} + - 1 {w}_{3} \qquad ( 4 )$$

$$v \leq - 4 {w}_{1} + 4 {w}_{2} + 1 {w}_{3} \qquad ( 5 )$$

$$v \leq 5 {w}_{1} + 0 {w}_{2} + - 2 {w}_{3} \qquad ( 6 )$$

$$v \leq - 5 {w}_{1} + 4 {w}_{2} + 1 {w}_{3} \qquad ( 7 )$$

$$Σ {w}_{i} = 1 \qquad ( 8 )$$

$${w}_{i} \geq 0 ∀ i \qquad ( 9 )$$

where z represents the value of the game or the objective function, v represents the value of the constraints, w₁ represents the optimal probability solution for the choice ‘Fire Mortar’, w₂ represents the optimal probability solution for the choice ‘Advance’, w₃ represents the optimal probability solution for the choice ‘Do Nothing’, and i represents the index of decision choice. Using a simplex algorithm to solve the linear program yields mixed strategy {0.2857, 0.7143, 0}. To maximize minimum gain, the player should fire a mortar approximately 29% of the time, advance 71% of the time, and do nothing none of the time.

In scenarios with very large reward matrices, the optional technique of subset summing may be applied. The subset summing algorithm reduces a constrained optimization problem to solving a series of simpler, reduced-dimension constrained optimization problems. Specifically, for a reward matrix consisting of P scenarios (columns), a set of 2^{P}−1 new reward matrices are created by incorporating unique subsets of the scenarios. To illustrate the generation of the subsets to be considered, the following mathematical equation (10) shows an example of constraints from the example of TABLE 1 where each row in the equation corresponds to a row in the reward matrix A. Each new reduced reward matrix is formed by multiplying A element-wise by a binary matrix. Each of the 2^{P}−1 binary matrices has a unique set of columns which are all-zero. The element-wise multiplication serves to mask out specific scenarios, leaving only specific combinations, or subsets, of the original scenarios to be considered. This operation increases the run time, but may be a necessary trade-off for improved accuracy. This method also ensures that the correct answer is found by computing the proper objective function. If, for example, A represents a reward matrix, then the solution for computing all combinations of rows is:

$$A {.}^{*} \begin{matrix}[ 1 & 1 & 0 & 1 \\ 1 & 1 & 0 & 1 \\ 1 & 1 & 0 & 1 ]\end{matrix} \qquad ( 10 )$$

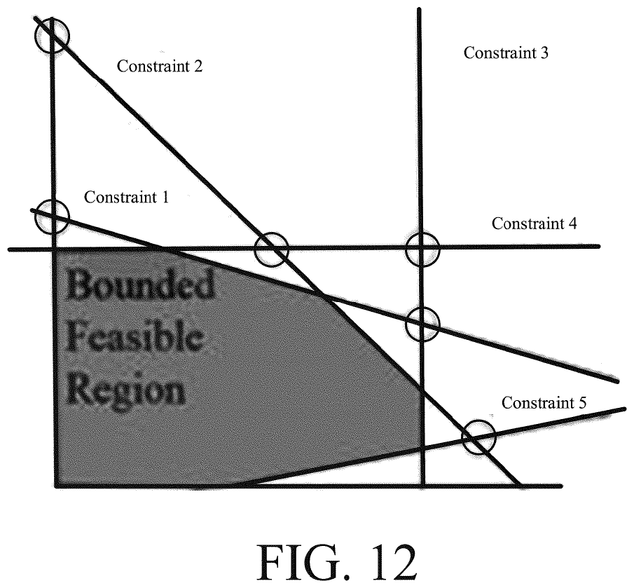

One reason for running all combinations of decisions, 2^{P}−1, where P is the number of columns in a reward matrix, is that one or more constraints eliminate(s) possible feasible solutions, as shown in FIG. 12 with circles. A feasible region is a graphical solution space for the set of all possible points of an optimization problem that satisfy the problem's constraints. Information is treated as parameters rather than constraints, so that a decision can be made outside of traditional feasible regions. This is why the present solution works robustly with complex data for general decision-making applications. Note that FIG. 12 is a simplified representation that could have as many as P dimensions.

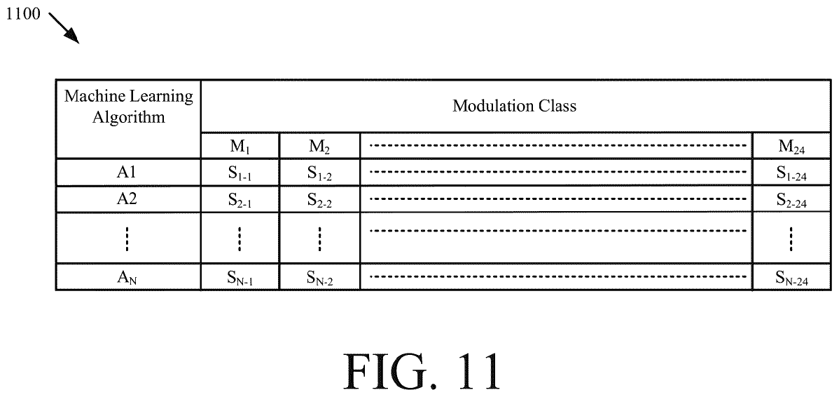

The above TABLE 1 can be modified in accordance with the present solution. For example, as shown in FIG. 11, each row of a table 1100 is associated with a respective machine learning algorithm of a plurality of machine learning algorithms, and each column is associated with a respective modulation class of a plurality of modulation classes. Each cell in the body of the table 1100 includes a likelihood score S. The likelihood scores can include, but are not limited to, goodness-of-fit-predicted scores calculated based on the number of signals and modulation classes. Each goodness-of-fit-predicted score describes how well the machine learned model and modulation class fit a set of observations. A measure of goodness-of-fit summarizes the discrepancy between observed values and the values expected under the machine learned model in question. The goodness-of-fit-predicted score can be determined, for example, using a chi-squared distribution algorithm and/or a likelihood ratio algorithm. The modulation classes can include, but are not limited to, frequency modulation, amplitude modulation, phase modulation, angle modulation, and/or line coding modulation.

The reward matrix illustrated by table 1100 can be constructed and solved using a linear program. For example, an interior-point algorithm can be employed. A primal standard form can be used to calculate optimal tasks and characteristics in accordance with the following mathematical equation (11).

$$maximize f ( x ) s . t . \qquad ( 11 )$$

$$A ( x ) \leq b$$

$$x \geq 0$$

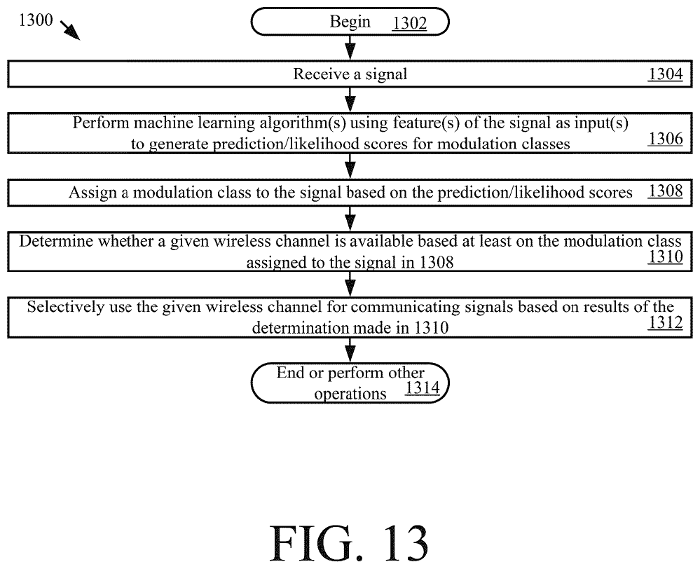

Referring now to FIG. 13, there is provided a flow diagram of an illustrative method 1300 for operating a communication device (e.g., communication device 202, 204 or 206 of FIG. 2). Method 1300 begins with 1302 and continues with 1304 where the communication device receives a signal (e.g., signal 700 of FIG. 7). In 1306, the communication device performs one or more machine learning algorithms (e.g., neural network(s)) using at least one feature of the signal (e.g., a frequency, phase, amplitude) as an input to generate a plurality of scores (e.g., goodness-of-fit-predicted scores). Each score represents a likelihood that the signal was modulated using a given modulation type of a plurality of different modulation types (e.g., ASK, PSK, QAM, and/or FM). A modulation class is assigned to the signal in 1308 based on the scores. For example, the signal is assigned a modulation class that is associated with the score having the greatest value. Alternatively, the signal is assigned a modulation class that is associated with a score that was selected based on results of an optimization algorithm (e.g., a game theory analysis).

Next in 1310, a determination is made by the communications device as to whether a given wireless channel (e.g., wireless channel 206 or 210 of FIG. 2) is available based on the modulation class assigned to the signal, a bit rate, and/or a center frequency of the signal. In some scenarios, a determination is made that the given wireless channel is unavailable when a decision is made that the primary user is not the source of the signal (e.g., based on the modulation class, bit rate of the signal and/or center frequency of the signal). A determination is made that the given wireless channel is unavailable when a decision is made that the primary user is the source of the signal (e.g., based on the modulation class, bit rate of the signal and/or center frequency of the signal).

The communication device performs operations in 1312 to selectively use the given wireless channel for communicating signals based on results of the determination made in 1310. For example, the given wireless channel is used by a secondary user (e.g., user 222 of FIG. 2) for communications when a decision is made that the same is available (e.g., when the primary user (e.g., user 220 of FIG. 2) is not the source of the signal thereby indicating that the primary user is not using the same). In contrast, the secondary user stops using the given wireless channel for communications when a decision is made that the same is unavailable (e.g., when the primary user is the source of the signal thereby indicating that the primary user is using the same). Subsequently, 1314 is performed where method 1300 ends or other operations are performed (e.g., return to 1304).

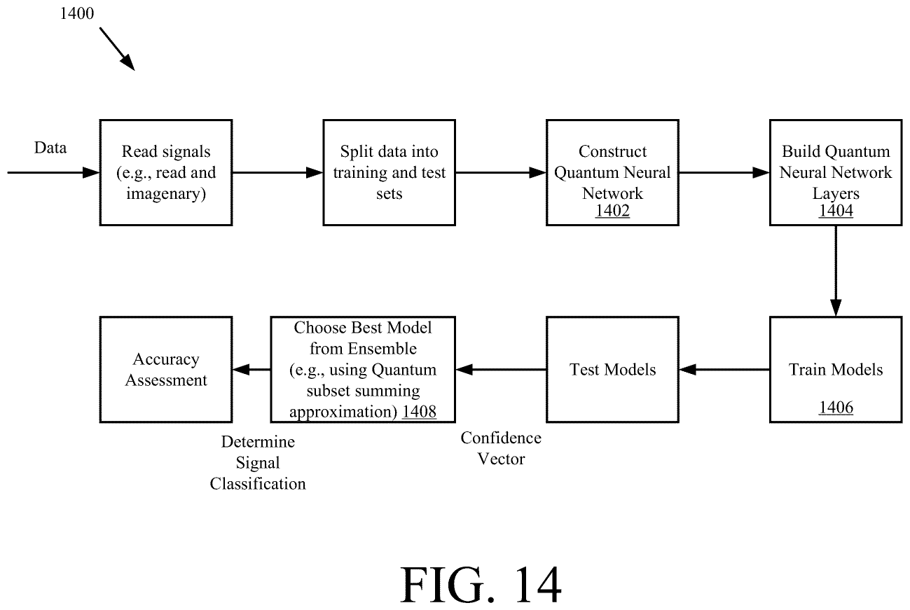

FIG. 14 provides an illustration of another illustrative signal classification system 1400 implementing quantum neural network(s) and quantum subset summing approximation. The signal classification system 1400 is generally configured to generate machine learned models including sets of signal features/characteristics that can be used to recognize and classify signals and/or sources of signals. These sets of signal features/characteristics are then stored in a datastore(s) and/or used by communication devices (e.g., communication device 202, 204, 206 of FIG. 2) to determine, for example, whether wireless channels are available or unavailable.

The communication devices can include, but are not limited to, cognitive radios configured to recognize and classify radio signals by modulation type at various SNRs. Each of the cognitive devices comprises a cognitive sensor employing machine learning algorithms. In some scenarios, the machine learned algorithms include quantum neural networks which are trained and tested using an extensive representative dataset consisting of 24 or more digital and analog modulations. The quantum neural networks learn from the time domain amplitude and phase information of the modulation schemes present in the training dataset. The quantum machine learning algorithms facilitate making preliminary estimations of modulation types and/or signal sources based on machine learned signal feature/characteristic sets. Linear programming optimization may be used to determine the best modulation classification based on prediction scores output from one or more machine learning algorithms. The communication device can significantly reduce the potentially massive memory storage requirements needed for training data by using compressive sensing techniques, such as but not limited to the DWT.

The quantum neural network layers constructed and built in blocks 1402, 1404 are trained in block 1406 to make decisions as to a modulation classification for a received signal based on one or more feature inputs for the received signal. The quantum neural network layers can be trained using modulation class data.

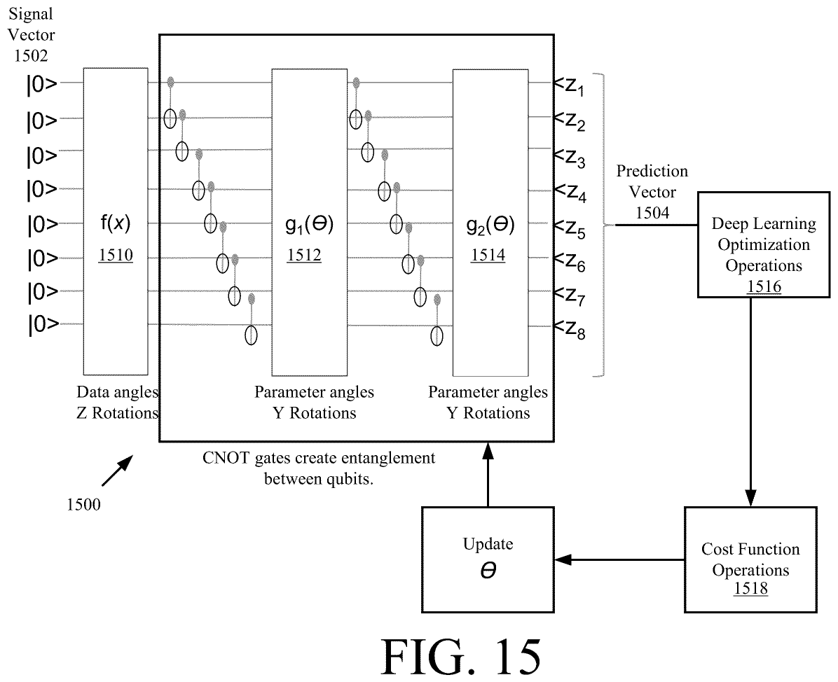

An illustrative quantum neural network 1500 is shown in FIG. 15. Quantum neural network 1500 may be implemented by one or more quantum processors. Quantum neural network 1500 uses the properties of quantum physics to store date and perform computations. quantum neural network 1500 may comprise specialized hardware on which qubits are stored, controlled and/or manipulated in accordance with the present solution. The term “qubit” is used to refer to a unit of quantum information. The unit of quantum information can also be called a quantum state. A single qubit is generally represented by a vector a|0>+b|1>, where a and b are complex coefficients and |0 [symbol] and |1 [symbol] are the basis vectors for the two-dimensional complex vector space of single qubits.

In the quantum neural network layers, a unitary operator is applied on a qubit by a sequence of rotations on a block sphere model of a qubit. The qubit is first rotated about the Z axis in accordance with a function ƒ(x) as shown by block 1510, followed by rotations about the Y axis in accordance with a function g₁ (θ) and a function g₂ (θ)) as shown by blocks 1512, 1514. Multiple g(θ) layers are used for parameter angle encoding. The first rotation about the Z axis handles the initial data, and the rotation about Y axis is being iteratively updated by the system. The initial data comprises a signal vector 1502 including principle components of the real and imaginary components of a received signal. Principle component analysis and principle components are well known. Any known or to be known principle component analysis can be used here to obtain the initial data. A prediction vector 1504 is output from block 1514 as a result of the qubit rotations. The prediction vector 1504 comprises a classification of one of a plurality of classification types.

The prediction vector 1504 is passed to block 1516 where deep learning optimization operations are performed by a plurality of solvers to minimize function g(θ)). The solvers can include, but are not limited to, Adam, Stochastic Gradient Decent Method, and/or RMSprop. The minimized function g(θ)) is passed to block 1518 in which cost function operations are performed to facilitate updating of the Y axis rotation angle θ. The cost function may be configured to minimize parameters over a dataset. The cost function can include, but is not limited to, a cross-entropy cost function which measures a difference between estimate (delta) and estimated value (prediction).

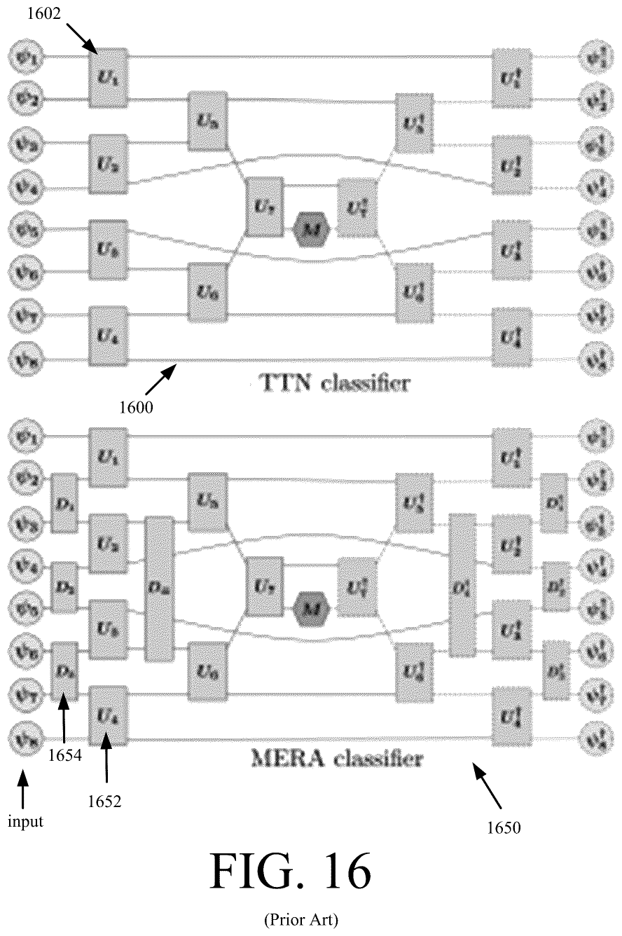

FIG. 16 provides illustrations of circuits that may be used to implement the quantum neural network layers 1510, 1512, 1514. The quantum classifier circuits 1600, 1650 have a hierarchical structure of eight qubits configured to perform binary classification of data encoded in a quantum state. Each quantum classifier circuit 1600, 1650 comprises unitary blocks 1602, 1652, 1654 and a measurement operator M. Quantum classifier circuits 1600, 1650 may be used to classify highly entangled quantum states. Each quantum classifier circuit 1600, 1650 is configured to operate on inputs φ and evaluate to an expectation value of M. Quantum classifier circuits 1600, 1650 are further described in a document entitled “Hierarchical quantum classifiers” written by Edward Grant et al. and published in the npj Quantum information journal, 4 (1), 65.

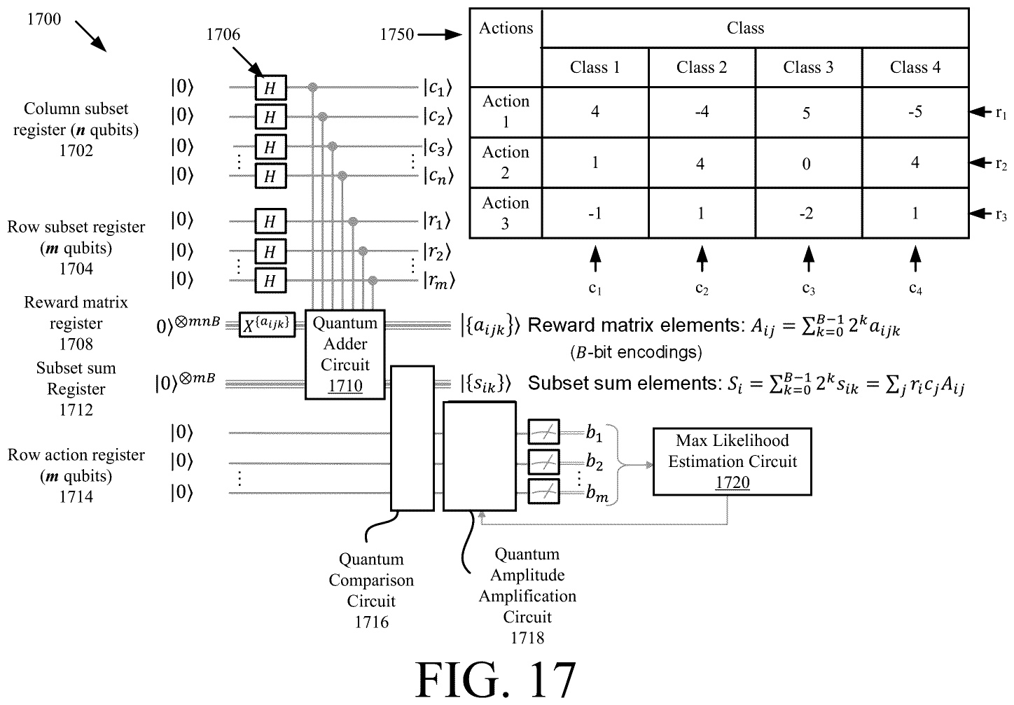

FIG. 17 provides an illustration that is useful for understanding quantum subset summing approximation which can be used to facilitate selection of which machine learned model of a plurality of machine learned models to use per signal. The operations of FIG. 17 can be performed in block 1408 of FIG. 14, and/or used to selected which machine learned model of a plurality of machine learned models to use for deep learning optimization in block 1516 of FIG. 15 for the signal based on qubit values in the row action register.

The quantum subset summing approximation may be implemented using a quantum processing circuit 1700. In this regard, the quantum processing circuit 1700 comprises registers 1702, 1704, 1708, 1712, 1714, a quantum adder circuit 1710, a quantum comparison circuit 1716, a quantum amplitude amplification circuit 1718, and a max likelihood estimation circuit 1720. The quantum adder circuit 1710 is generally configured to assemble complex data sets for comparison and processing. The quantum comparison circuit 1716 is generally configured to implement conditional statements in quantum computation.

The quantum processing circuit 1700 is configured to perform a true superposition of subset summing of a reward matrix. Table 1750 of FIG. 17 shows an illustrative reward matrix. Reward matrix 1750 comprises a plurality of rows r_{y} and a plurality of columns cx. Each row has an action assigned thereto. For example, a first row r₁ has an Action1 (e.g., fire mortar) assigned thereto. A second row r₂ has an Action2 (e.g., advance) assigned thereto. A third row r₃ has an Action3 (e.g., do nothing) assigned thereto. Each column has a class assigned thereto. For example, a first column c₁ has an Class1 (e.g., an enemy truck) assigned thereto. A second column c₂ has an Class2 (e.g., a civilian truck) assigned thereto. A third column c₃ has an Class3 (e.g., an enemy tank) assigned thereto. A fourth column c₄ has an Class3 (e.g., a friendly tank) assigned thereto. A value is provided in each cell which falls within a given range, e.g., −5 to 5.

In order to subset sum the reward matrix, the quantum processing circuit 1700 is configured to compute a row sum of all possible subset matrices using different combinations of n qubits stored in the column subset register 1702 and m qubits stored in the row subset register 1704. The n qubits stored in the row subset register 1704 represent goodness-of-fit metrics for each of the solvers used to assign modulation classes to signals (e.g., Adam, Stochastic Gradient Decent Method, and/or RMSprop). The m qubits stored in the row subset register 1704 represent goodness-of-fit metrics and probabilities that are returned from the algorithm that helps select a modulation class. The information stored in register 1702 include the parameters based on modulation classes. So, for example, if there are three solvers solving the problem as to which of the twenty-four modulation classes should be assigned to a received signal, then there would be twenty-four rows (one corresponding to each modulation class) and three columns (one corresponding to each solver). The number of subset combinations of rows and columns scales exponentially with the number of rows and columns in the reward matrix. However, if this is done in quantum superposition, the system is matching the exponential scaling of the state space of a set of qubits in superposition with that exponential scaling problem of subset summing.

Each of the registers 1702 and 1704 is configured so that a zero value indicates that a row or column is not included in a given subset, and a one value indicates that the row or column is included in the given subset. Each of the quantum logic gates 1706 is configured to convert an initial zero state into an equal superposition of zero and one. If this is done with all row and column register qubits, then the system generates an equal superposition over all possible combinations of zeros for all possible bitstrings.

The reward matrix data is loaded into a reward matrix register 1708. Next, multi-controlled adder operations are performed by the quantum adder circuit 1710 to add up only those reward matrix register elements corresponding to columns and rows that are in the one state. Since the qubits are in superposition, the quantum adder circuit 1710 is simultaneously performing the adder operation for all exponentially many subset combinations. The value of each row sum is output to a subset sum register 1712. Each subset has a plurality of rows associated therewith, and the quantum adder circuit 1710 outputs the sum of each row within each subset.

The quantum comparison circuit 1716 is configured to compare the row sums for each subset to identify the highest row sum. The qubit (corresponding to the highest row sum) in a row action register 1714 is flipped to a one to indicate that this is the row with the highest sum in a given subset. Each time a qubit is assigned a one value its probability amplitude in an overall superposition increases.

Next, amplitude amplification operations are performed with a feedback loop of a maximum likelihood estimation circuit 1720. This is performed to amplify a highest of the probability amplitudes arbitrarily close to one and de-amplifies the remaining probability amplitudes close to zero so that after a plurality of rounds a certain accuracy is ensured.

The quantum processing circuit 1700 makes a decision as to which machine learned model of a plurality of machine learned models to use per signal based on qubit values in the row action register. For example, the quantum processing circuit 1700 may determine that a stochastic Gradient Decent Method based solver is to be used for a first signal, and/or an RMSprop based solver is to be used for a second signal.

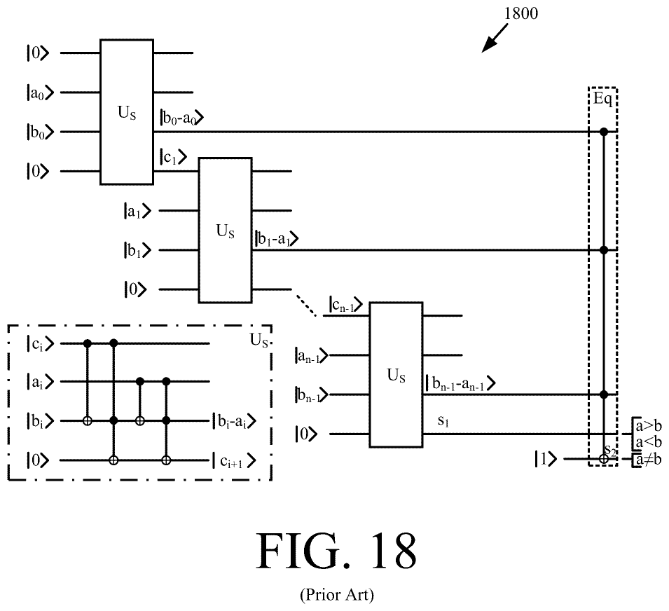

FIG. 18 provides an illustration of a quantum comparator circuit 1800. Quantum comparison circuit 1716 of FIG. 17 may be the same as or similar to quantum comparator circuit 1800. Quantum comparator circuit 1800 comprises a quantum bit string comparator configured to compare two strings of qubits aₙ and bₙ using subtraction. Quantum comparator circuit 1800 is well known and described in a document entitled “Quantum bit string comparator: circuits and applications” written by Oliveira et al. and published in Quantum Computers and computing, 7(1), 17-26. Still, it should be understood that each string comprises n qubits representing a given number. Qubit string aₙ can be written as aₙ=aₙ₋₁, . . . , a₀, where a₀ is the lowest order bit. Qubit string bₙ can be written as bₙ=bₙ₋₁, . . . , b₀, where b₀ is the lowest order bit. The qubits are stored in quantum registers using quantum gate operators.

This comparison is performed to determine whether the qubit string aₙ is greater than, less than or equal to the qubit string bₙ. The comparison operation is achieved using a plurality of quantum subtraction circuits Us. Each quantum subtraction circuit is configured to subtract a quantum state |a [symbol] from a quantum state |b [symbol] via xor (⊕) operations, and pass the result |bᵢ−aᵢ [symbol] to a quantum gate circuit Eq. A quantum state for a control bit c is also passed to a next quantum subtraction circuit for use in a next quantum subtraction operation. The last quantum subtraction circuit outputs a decision bit s₁. If the qubit string aₙ is greater than the qubits string bₙ, then an output bit s₁ is set to a value of 1. If the qubit string aₙ is less than the qubits string bₙ, then an output bit s₁ is set to a value of 0.

The quantum gate circuit Eq orders the subtraction results and uses the ordered subtraction results |b₀−a₀ [symbol] , |b₁−a₁ [symbol] , . . . |bₙ₋₁−aₙ₋₁ [symbol] to determine whether the qubit string aₙ is equal to the qubits string bₙ. If so, an output bit s₂ is set to a value of 1. Otherwise, the output bit s₂ is set to a value of 0.

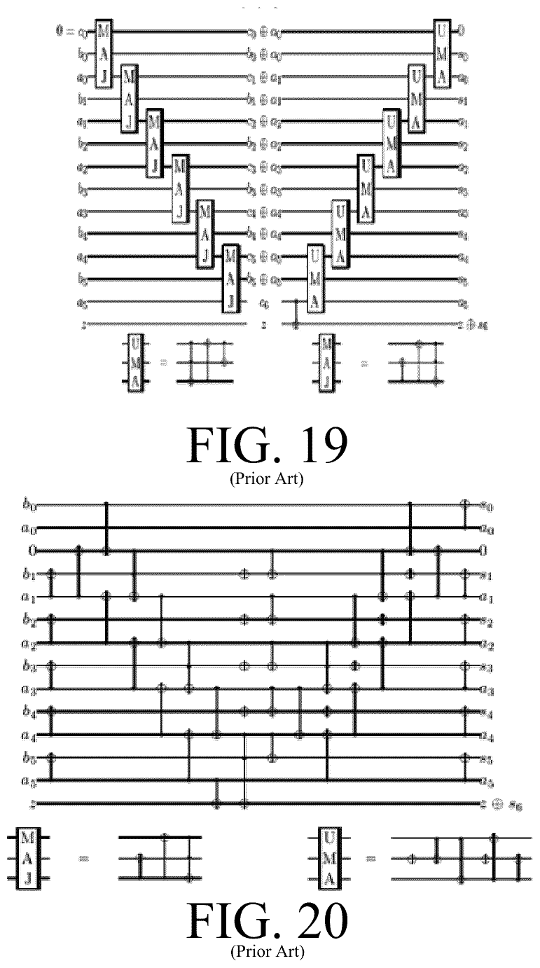

FIGS. 19 and 20 show illustrations of quantum adder circuits 1900, 2000. Quantum adder circuit 1710 of FIG. 17 may be the same as or similar to quantum adder circuit(s) 1900, 2000. Quantum adder circuit(s) 1900, 2000 are well known and described in a document entitled “A new quantum ripple-carry addition circuit” written by Cuccara et al. and published in arXiv preprint quant-ph/0410184.

Quantum adder circuit(s) 1900, 2000 comprise a quantum ripple-carry addition circuit configured to compute a sum of the two strings of qubits aₙ and bₙ together. The quantum ripple-carry addition circuits should in FIGS. 19-20 are well known. The circuits of FIGS. 19-20 implement an in-place majority (MAJ) gate with two Conditioned-NOT (CNOT) gates and one Toffoli gate. The MAJ gate is a logic gate that implements the majority function via xor (⊕) operations. In this regard, the MAJ gate computes the majority of three bits in place. The MAJ gate outputs a high when the majority of the three input bits are high value, or outputs a low when the majority of the three input bits are low. The circuit of FIG. 19 implements a 2-CNOT version of the UnMajority and Add (UMA) gate, while the circuit of FIG. 20 implements a 3-CNOT version of the UMA gate. The UMA gate restores some of the majority computation, and captures the sum but in the b operand.

The qubit string aₙ can be written as aₙ=aₙ₋₁, . . . , a₀, where a₀ is the lowest order bit. Qubit string bₙ can be written as bₙ=bₙ₋₁, . . . , b₀, where b₀ is the lowest order bit. Qubit string aₙ is stored in a memory location Aₙ, and qubit string bₙ is stored in a memory location Bₙ. Cₙ represents a carry bit. The MAJ gate writes Cn+1 into Aₙ, and continues a computation using Cn+1. When done using Cₙ₊₁, the UMA gate is applied which restores aₙ to Aₙ, restores cₙ to Aₙ₋₁, and writes sₙ to Bₙ.

Both circuits of FIGS. 19-20 are shown for strings including six bits. The present solution is not limited in this regard. A person skilled in the art would understand that the circuits of FIGS. 19-20 can be modified for any number of bits n in strings aₙ and bₙ.

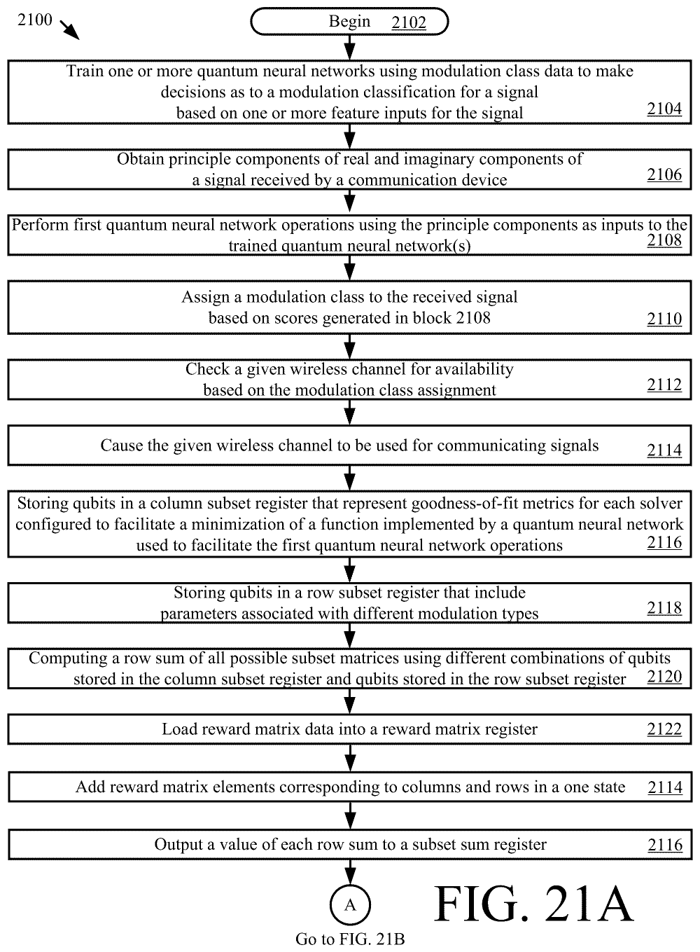

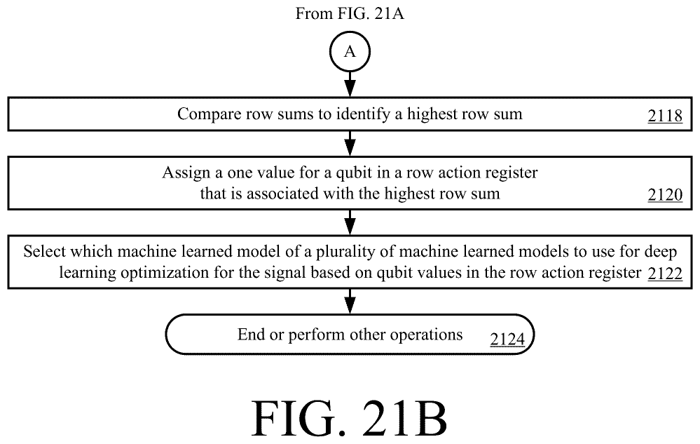

Referring now to FIG. 21, there is provided a flow diagram of an illustrative method 2100 for operating a quantum processor (e.g., quantum processor 1700 of FIG. 17). The operations of method 2100 can be performed in the same or different order than that shown. For example, the operations of blocks 2104-2114 may be performed subsequent to the operations of blocks 2116-2122. The present solution is not limited in this regard. Other orders of the operations can be performed in accordance with a given application.

Method 2100 begins with 2102 and continues with 2104 where one or more quantum neural networks are trained using modulation class data to make decisions as to a modulation classification for a signal based on one or more feature inputs for the signal. The modulation class data can include, but is not limited to, the data of table 500 shown in FIG. 5, modulation class identifiers, modulation parameters for each modulation type of a plurality of different modulation types, machine learned model identifiers, solver identifiers, receive signal parameters, and/or expected outputs of different solvers.

In next block 2106, the quantum processor obtains principle components of real and imaginary components of a signal received by a communication device. Techniques for performing a principle component analysis of real and imaginary numbers are well known. Any known or to be known principle component analysis technique can be used here. The quantum processor performs first quantum neural network operations in block 2108 using the principle components as inputs to the trained quantum neural network(s). The first quantum neural network operations may be performed in accordance with the quantum circuit 1500 shown in FIG. 15. A plurality of scores are generated by the performance of the first quantum neural network operations. Each score represents a likelihood that the received signal was modulated using a given modulation type of a plurality of different modulation types.

In blocks 2110-2114, the quantum processor performs operations to: assign a modulation class to the received signal based on the scores; check a given wireless channel for availability based at least on the modulation class assigned to the signal; and cause the given wireless channel to be used for communicating signals when a determination is made that the given wireless channel is available. The operations of block 2114 may involve: (re) configuring a channel parameter setting of a communication device; and/or controlling communication operations of the communication device such that signals are received and transmitted on the given channel.

In blocks 2116-2120, the quantum processor performs second quantum neural network operations for selecting which machine learned model of a plurality of machine learned models to use for deep learning optimization (e.g., in block 1516 of FIG. 15). The second quantum neural network operations involve: storing qubits in a column subset register (e.g., column subset register 1702 of FIG. 17) representing goodness-of-fit metrics for each of a plurality of solvers configured to facilitate a minimization of a function implemented by a quantum neural network used to facilitate the first quantum neural network operations; and storing the qubits in a row subset register (e.g., row register 1704 of FIG. 17) that include parameters associated with the different modulation types. The solvers can include, but are not limited to, a solver implementing Adam, a solver implementing a Stochastic Gradient Decent Method, and/or a solver implementing RMSprop. The second quantum neural network operations also comprise computing a row sum of all possible subset matrices using different combinations of qubits stored in the column subset register and qubits stored in the row subset register. Prior to the row sum computation, block 2120 may involve converting an initial zero state of each qubit in the row subset register and the column subset register into an equal superposition of zero and one.

In block 2122, reward matrix data is loaded into a reward matrix register (e.g., reward matrix register 1708 of FIG. 17). The quantum processor then adds only reward matrix register elements corresponding to columns and rows that are in a one state, as shown by block 2124. A value of each row sum is output to a subset sum register (e.g., subset sum register 1712 of FIG. 17) in block 2116.

The second neural network operations may further comprise the operations of blocks 2118-2122 in FIG. 21B. As shown in FIG. 21B, these operations involve: comparing row sums to identify a highest row sum; assigning a one value for a qubit in a row action register (e.g., row action register 1714 of FIG. 17) that is associated with the highest row sum; and selecting which machine learned model of a plurality of machine learned models to use for deep learning optimization for the signal based on qubit values in the row action register. The machine learning models can include, but are not limited to, Adam, Stochastic Gradient Decent Method, and or RMSprop. Subsequently, method 2100 continues to block 2124 where it ends or other operations are performed (e.g., return to 2102).

As evident from the above discussion, the present solution concerns methods for operating a quantum processor. The methods comprise: training one or more quantum neural networks using modulation class data to make decisions as to a modulation classification for a signal based on one or more feature inputs for the signal; obtaining, by the quantum processor, principle components of real and imaginary components of a signal received by a communication device; performing first quantum neural network operations by the quantum processor using the principle components as inputs to the trained one or more quantum neural networks to generate a plurality of scores; assigning a modulation class to the received signal based on the plurality of scores; determining whether a given wireless channel is available based at least on the modulation class assigned to the signal; and/or causing the given wireless channel to be used for communicating signals when a determination is made that the given wireless channel is available. Each score represents a likelihood that the received signal was modulated using a given modulation type of a plurality of different modulation types.

The methods also comprise performing second quantum neural network operations that comprise computing a row sum of all possible subset matrices using different combinations of qubits stored in a column subset register and qubits stored in a row subset register. The qubits stored in the row subset register represent goodness-of-fit metrics for each of a plurality of solvers configured to facilitate a minimization of a function implemented by a quantum neural network used to facilitate the first quantum neural network operations. The qubits stored in the column subset register include parameters associated with the plurality of different modulation types. An initial zero state of each qubit in the row subset register and the column subset register into an equal superposition of zero and one.

The second neural network operations may also comprise: loading reward matrix data into a reward matrix register; adding only reward matrix register elements corresponding to columns and rows that are in a one state; outputting a value of each row sum to a subset sum register; comparing row sums to identify a highest row sum; assigning a one value for a qubit in a row action register that is associated with the highest row sum; and or selecting which machine learned model of a plurality of machine learned models to use for deep learning optimization for the signal based on qubit values in the row action register.

The present solution also concerns a quantum circuit. The quantum circuit comprises: one or more quantum neural networks trained using modulation class data to make decisions as to a modulation classification for a signal based on one or more feature inputs for the signal; and a quantum processor. The quantum processor is configured to: obtain principle components of real and imaginary components of a signal; perform first quantum neural network operations using the principle components as inputs to the one or more quantum neural networks to generate a plurality of scores; assign a modulation class to the received signal based on the plurality of scores; determine an availability of a given wireless channel based at least on the modulation class assigned to the signal; and or cause the given wireless channel to be used for communicating signals when a the given wireless channel is available. Each score represents a likelihood that the signal was modulated using a given modulation type of a plurality of different modulation types.

The quantum processor may also be configured to perform second quantum neural network operations that comprise computing a row sum of all possible subset matrices using different combinations of qubits stored in a column subset register and qubits stored in a row subset register. The qubits stored in the row subset register represent goodness-of-fit metrics for each of a plurality of solvers configured to facilitate a minimization of a function implemented by a quantum neural network used to facilitate the first quantum neural network operations. The qubits stored in the column subset register include parameters associated with the plurality of different modulation types.

The second neural network operations may also comprise: converting an initial zero state of each qubit in the row subset register and the column subset register into an equal superposition of zero and one; loading reward matrix data into a reward matrix register; adding only reward matrix register elements corresponding to columns and rows that are in a one state; outputting a value of each row sum to a subset sum register; comparing row sums to identify a highest row sum; assigning a one value for a qubit in a row action register that is associated with the highest row sum; and or selecting which machine learned model of a plurality of machine learned models to use for deep learning optimization for the signal based on qubit values in the row action register.

The present solution also concerns a communication device comprising: a wireless communications circuit configured to receive a signal; and a quantum circuit. Wireless communications circuits are well known. Any known or to be known wireless communication circuit can be used here. The quantum circuit comprises: one or more quantum neural networks trained using modulation class data to make decisions as to a modulation classification for the signal based on one or more feature inputs for the signal; and a quantum processor. The quantum processor is configured to: obtain principle components of real and imaginary components of the signal; perform first quantum neural network operations using the principle components as inputs to the one or more quantum neural networks to generate a plurality of scores (wherein each said score represents a likelihood that the signal was modulated using a given modulation type of a plurality of different modulation types); and select which machine learned model of a plurality of machine learned models to use for deep learning optimization for the signal based on qubit values in the row action register that were obtained via understanding quantum subset summing approximation.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for operating a quantum processor, comprising:
training one or more quantum neural networks using modulation class data to make decisions as to a modulation classification for a signal based on one or more feature inputs for the signal;
obtaining, by the quantum processor, principle components of real and imaginary components of a signal received by a communication device; and
performing first quantum neural network operations by the quantum processor using the principle components as inputs to the trained one or more quantum neural networks to generate a plurality of scores, each said score representing a likelihood that the received signal was modulated using a given modulation type of a plurality of different modulation types.

2. The method according to claim 1, further comprising:
assigning a modulation class to the received signal based on the plurality of scores;
determining whether a given wireless channel is available based at least on the modulation class assigned to the signal; and
causing the given wireless channel to be used for communicating signals when a determination is made that the given wireless channel is available.

3. The method according to claim 1, further comprising performing second quantum neural network operations that comprise computing a row sum of all possible subset matrices using different combinations of qubits stored in a column subset register and qubits stored in a row subset register.

4. The method according to claim 3, wherein the qubits stored in the row subset register represent goodness-of-fit metrics for each of a plurality of solvers configured to facilitate a minimization of a function implemented by a quantum neural network used to facilitate the first quantum neural network operations.

5. The method according to claim 3, wherein the qubits stored in the column subset register include parameters associated with the plurality of different modulation types.

6. The method according to claim 3, wherein the second neural network operations further comprise converting an initial zero state of each qubit in the row subset register and the column subset register into an equal superposition of zero and one.

7. The method according to claim 3, wherein the second neural network operations further comprise:
loading reward matrix data into a reward matrix register;
adding only reward matrix register elements corresponding to columns and rows that are in a one state; and
outputting a value of each row sum to a subset sum register.

8. The method according to claim 7, wherein the second neural network operations further comprise:
comparing row sums to identify a highest row sum; and
assigning a one value for a qubit in a row action register that is associated with the highest row sum.

9. The method according to claim 8, further comprising selecting which machine learned model of a plurality of machine learned models to use for deep learning optimization for the signal based on qubit values in the row action register.

10. A quantum circuit, comprising:
one or more quantum neural networks trained using modulation class data to make decisions as to a modulation classification for a signal based on one or more feature inputs for the signal;
a quantum processor configured to:
obtain principle components of real and imaginary components of a signal; and
perform first quantum neural network operations using the principle components as inputs to the one or more quantum neural networks to generate a plurality of scores, wherein each said score represents a likelihood that the signal was modulated using a given modulation type of a plurality of different modulation types.

11. The quantum circuit according to claim 10, wherein the quantum processor is further configured to:
assign a modulation class to the received signal based on the plurality of scores;
determine an availability of a given wireless channel based at least on the modulation class assigned to the signal; and
cause the given wireless channel to be used for communicating signals when a the given wireless channel is available.

12. The quantum circuit according to claim 10, wherein the quantum processor is further configured to perform second quantum neural network operations that comprise computing a row sum of all possible subset matrices using different combinations of qubits stored in a column subset register and qubits stored in a row subset register.

13. The quantum circuit according to claim 12, wherein the qubits stored in the row subset register represent goodness-of-fit metrics for each of a plurality of solvers configured to facilitate a minimization of a function implemented by a quantum neural network used to facilitate the first quantum neural network operations.

14. The quantum circuit according to claim 12, wherein the qubits stored in the column subset register include parameters associated with the plurality of different modulation types.

15. The quantum circuit according to claim 12, wherein the second neural network operations further comprise converting an initial zero state of each qubit in the row subset register and the column subset register into an equal superposition of zero and one.

16. The quantum circuit according to claim 12, wherein the second neural network operations further comprise:
loading reward matrix data into a reward matrix register;
adding only reward matrix register elements corresponding to columns and rows that are in a one state; and
outputting a value of each row sum to a subset sum register.

17. The quantum circuit according to claim 16, wherein the second neural network operations further comprise:
comparing row sums to identify a highest row sum; and
assigning a one value for a qubit in a row action register that is associated with the highest row sum.

18. The quantum circuit according to claim 17, wherein the quantum processor is further configured to select which machine learned model of a plurality of machine learned models to use for deep learning optimization for the signal based on qubit values in the row action register.

19. A communication device, comprising:
a wireless communications circuit configured to receive a signal;
a quantum circuit, comprising:
one or more quantum neural networks trained using modulation class data to make decisions as to a modulation classification for the signal based on one or more feature inputs for the signal;
a quantum processor configured to:
obtain principle components of real and imaginary components of the signal; and
perform first quantum neural network operations using the principle components as inputs to the one or more quantum neural networks to generate a plurality of scores, wherein each said score represents a likelihood that the signal was modulated using a given modulation type of a plurality of different modulation types.

20. The communication device according to claim 19, wherein the quantum processor is further configured to select which machine learned model of a plurality of machine learned models to use for deep learning optimization for the signal based on qubit values in the row action register that were obtained via understanding quantum subset summing approximation.
